(19) United States
(12) Patent Application Publication
(10) Pub. No.: US 2022/0343001 A1
(43) Pub. Date: Oct. 27, 2022

(54) Methods and system for software application data auditability through encrypted log chain

(71) Applicants: Miguel FONCERRADA, Washington, DC (US); Kurt LINDBERG, Reston, VA (US)

(72) Inventors: Miguel FONCERRADA, Washington, DC (US); Kurt LINDBERG, Reston, VA (US)

(21) Appl. No.: 17/239,628

(22) Filed: Apr. 25, 2021

(51) Int. Cl. G06F 21/60; G06F 16/23

(52) U.S. Cl. CPC G06F 21/602; G06F 16/2358

(57) ABSTRACT

Method and processes for encrypting database records or columns from within a software application with the ability to detect modifications to the data performed external to the application. Optionally, the encryption can be performed using both an internal application key and a key provided by an external source. Such as a governmental agency wishing to verify the integrity of the data. Each column that should be tracked for change history is defined and an encrypted record of each change is maintained.

### CROSS-REFERENCE TO RELATED APPLICATIONS

Provisional patent application No. 62/982,851

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Source code listed starting on page 14.

### BACKGROUND OF THE INVENTION

The invention is a method for data auditability through an encrypted log chain. The invention pertains to the field of software and is applicable to related fields including aviation, finance, medical and other industries where it can be used to certify the veracity of certificates issued at specific time based on the data as it existed at that time. Certificates related to aircraft, aircraft parts and components and the maintenance thereof are an example of how the auditability can be used. The invention also has wide applicability for verification of data entry and the tracking of modifications to such data.

The keeping of electronic records is now common. One problem with electronic records is verification that those records have not been altered or to provide clear auditable proof of how and when they have been changed. It is a common practice in many fields to keep signed papers documenting and certifying the actions taken. This is common in aviation maintenance where certificates (or forms) of maintenance actions or findings are stamped or signed in a paper trail.

Software applications often have security functionality built in to prevent unauthorized changing of data. However, the security measures are often insufficient to prevent technically competent actors from being able to change data behind the reach of the application. The users must be granted certain rights to update the database to be able to write data as part of their normal duties, hence they have rights to access the database. An actor can use this access to update database records without going through the application, thereby bypassing the security embedded in the application. The invention provides for an audit trail showing the history of prior and current value of a field (often referred to as a tuple. i.e., the intersection of a row and column in a database).

### BRIEF SUMMARY OF THE INVENTION

### The Object of the Invention

Is to provide auditability to data changes in a database. The specific applicability of the invention is widespread across industries and here illustrated by its application in the aviation industry where trusted certificates and auditable modification to the underlying data is a necessary requirement.

### A BRIEF SUMMARY

Method and processes for encrypting database records or columns from within a software application with the ability to detect modifications to the data performed external to the application. Optionally, the encryption can be performed using both an internal application key and a key provided by an external source. Such as a governmental agency wishing to verify the integrity of the data. Each column that should be tracked for change history is defined and an encrypted record of each change is maintained.

If the user makes a change to the tracked data through the application, then that change is encrypted and properly logged. This maintains a valid audit trail and the integrity of the data is maintained.

If a change is made to the data outside of the application, then integrity will be lost. This is because It is impossible to make a change outside of the application, and properly log the change without knowing the encryption key.

Data that does not have a proper audit trail can be easily identified, because of a mismatch between the data and the encrypted audit trail.

Applicable to many different fields especially those requiring the auditability of data to certify actions taken.

### DETAILED DESCRIPTION OF THE INVENTION

### The Description

Software applications often have security functionality built in to prevent unauthorized changing of data. However, the security measures are often insufficient to prevent technically competent actors from being able to change data behind the reach of the application. The users must be granted certain rights to update the database to be able to write data as part of their normal duties, hence they have rights to access the database. An actor can use this access to update database records without going through the application, thereby bypassing the security embedded in the application. The invention provides for an audit trail showing the history of prior and current value of a field (often referred to as a tuple. i.e., the intersection of a row and column in a database).

The history must be maintained in an encrypted manner to prevent the modification of both the field and the audit record. Additionally, a way to detect if the encrypted audit records have been altered must be detectable and reportable. E.g., if the value of a field containing “123” is changed to “456” and the audit record is written, it must be detectable if the field is changed back to “123” and the last audit record is deleted.

### The Application

The inventors have conceived of novel technology that, for the purpose of illustration, is disclosed herein as applied in the context of enabling audit capabilities to the data generated by a software application. While the disclosed applications of the inventors' technology satisfy a long-felt but unmet need in the art of application data auditing, it should be understood that the inventors' technology is not limited to being implemented in the precise manners set forth herein but could be implemented in other manners without undue experimentation by those of ordinary skill in the art in light of this disclosure. Accordingly, the examples set forth herein should be understood as being illustrative only and should not be treated as limiting.

The disclosed technology may be implemented in a variety of manners in order to record information and retrieve information to verify the chain of values in a data field.

The system may be implemented in any type of software but most commonly will be used in software that should guarantee the auditability of its data, such as those software applications used in the medical, aviation, transportation, financial industries but not limited to those.

It should be understood that any one or more of the teachings, expressions, embodiments, examples, etc. described herein may be combined with anyone or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

### The Process

1. The methods and process for keeping an encrypted database record of the changes to all or certain defined columns from within an application.
2. An “internal-key” is maintained inside the application so as to ensure all encryption/decryption is only done through the application.
3. An additional key can be added as an option. We refer to this as the “external-authority key.”
4. The application shall have a way to define which columns should be tracked for changes. They can be a single or all columns in a record for each table in the database.
5. When a column is defined as being trackable an encrypted record is created in a table containing the details and date-time of the action.
   The record contains the following fields in no specific order:
   a. Unique change record identifier.
   b. Change date and time.
   c. Change by userid.
   d. Change original (from) value.
   e. Change new (to) value.
   f. Change table-name.
   g. Change column-name.
   h. Primary Key field one of table changed.
   i. Primary Key field two, if applicable, of table changed.
   j. Primary Key field three, if applicable, of table changed.
   k. Primary Key field four, if applicable, of table changed.
   l. Primary Key field five, if applicable, of table changed.
   m. Primary Key value one of table changed.
   n. Primary Key value two of table changed.
   o. Primary Key value three of table changed.
   p. Primary Key value four of table changed.
   q. Primary Key value five of table changed.
   r. Previous Change ID.
   s. Hash Value of this row.
      Note that the order of these 13 fields is not available to the user.
      Hash value includes:
         Number of audit records for this primary key before insert.
         Change Id.
         Change date and time.
         User date and time.
         Change table-name.
         Change column-name.
         All five primary key values.
         Change value from.
         Change value to.
         Previous Change ID.
   t. Hash value of the previous change for the same primary key.
6. When the application processes a change to a tracked column it writes another audit record exactly as detailed above. To ensure integrity of the audit-trail, the previous hash-value and the new audit-record count are included in the hash value.

### Integrity Test:

Integrity of the audit-trail is checked every time the user views the audit trail for a specific tracked field.

There is also a process to review all tracked fields and identify where the integrity has been compromised.

There can be people, as designated by the competent authority, that are given permissions to reset integrity for a given primary key or throughout the whole system. These people will be part of the user defined encryption key that the application installs.
1. Audit trail integrity.
   Any missing audit-trail records can be identified using two fields.
   First, each audit-trail record saves the audit-trail row number for that primary key. And second, each audit-trail record saves, the encrypted previous record.
   To check an audit-trail record, find the previous audit-trail record using the row number. Check that the previous-encrypted-audit-trail field on the audit-record matches the actual encrypted audit-trail of the previous record.
   Check that the row-counts on each record are sequential starting with zero.
   Check that there is at least one audit-trail record for every primary-key in the data.
2. Audit trail matches data.
   Check that the current data value of the field matches the ‘change-to’ value on the last audit-trail record. To find the last row, use the row-count that is encrypted on every row.
3. Audit trail identifies missing data.
   Check that if a primary-key exists in the encrypted audit-trail, that it also exists in the data.

### Encryption:

1. Encryption utilizes the method used by block-chain.
   This requires one or two keys.
2. The first encryption key can be embedded in the application software.
3. Optionally, that key can be supplemented by an additional key provided by competent authority. E.g., for aviation businesses the Federal Aviation Administration (or appropriate agency in other countries) can provide the application provider a plain text key or an executable with obfuscated key to be incorporated into producing and decrypting the audit records.
   As an example, the competent authority could provide a small executable that would accept a date-time value and return a key to be joined to the application internal key and used to encrypt the history of the data field.

What is claimed:

1. Methods and process for keeping an encrypted database record of the changes to all or certain defined columns from within an application.

2. Method of claim 1: Wherein a key is used to ensure all encryption/decryption is done through the application

3. Method of claim 2: Wherein an internal key can be built into the application

4. Method of claim 2: Wherein an external key can be provided by a suitable agency and used within the application

5. Method of claim 1: Wherein the columns to be tracked are defined.

6. Method of claim 1: Wherein encrypted record is created in a table containing the details and date-time of the action. The record contains the following fields in no specific order:
a. Unique change record identifier.
b. Change date and time.
c. Change by userid.
d. Change original (from) value.
e. Change new (to) value.
f. Change table-name.
g. Change column-name.
h. Primary Key field one of table changed.
i. Primary Key field two, if applicable, of table changed.
j. Primary Key field three, if applicable, of table changed.
k. Primary Key field four, if applicable, of table changed.
l. Primary Key field five, if applicable, of table changed.
m. Primary Key value one of table changed.
n. Primary Key value two of table changed.
o. Primary Key value three of table changed.
p. Primary Key value four of table changed.
q. Primary Key value five of table changed.
r. Previous Change ID.
s. Hash Value of this row.
i. Number of audit records for this primary key before insert.
ii. Change Id.
iii. Change date and time.
iv. User date and time.
v. Change table-name.
vi. Change column-name.
vii. All five primary key values.
viii. Change value from.
ix. Change value to.
x. Previous Change ID.
xi. Modifications to this list and order of the fields is not important.
t. Hash value of the previous change for the same primary key.

7. Method of claim 1: Wherein the external documents produced from this data can now be trusted as being auditable.
